(19) United States
(12) Patent Application Publication
(10) Pub. No.: US 2021/0212175 A1
(43) Pub. Date: Jul. 8, 2021

(54) THERMALLY-INSULATED INDUCTION HEATING MODULES AND RELATED METHODS

(71) Applicant: CONCEPT GROUP LLC, Wellesley, MA (US)

(72) Inventors: David H. REID, Jr., Fort Pierce, FL (US); Aarne H. REID, Jupiter, FL (US); Shriram RADHAKRISHNAN, West Palm Beach, FL (US); Michael Cline MURRAY, Jupiter, FL (US); Peter ROACH, Jacksonville, FL (US)

(21) Appl. No.: 17/048,123

(22) PCT Filed: Apr. 16, 2019
(86) PCT No.: PCT/US2019/027682

§ 371 Date: Oct. 16, 2020

Related U.S. Application Data
(60) Provisional application No. 62/658,022, filed on Apr. 16, 2018.
(60) Provisional application No. 62/773,816, filed on Nov. 30, 2018.
(60) Provisional application No. 62/811,217, filed on Feb. 27, 2019.
(60) Provisional application No. 62/825,123, filed on Mar. 28, 2019.

(51) Int. Cl. H05B 6/10; B29C 64/295; B33Y 30/00; B22F 12/13; B33Y 40/10

(52) U.S. Cl. CPC H05B 6/105; B29C 64/295; B33Y 40/10; B22F 12/13; B33Y 30/00

(57) ABSTRACT

Provided are thermally insulated modules that comprise a first shell and a first component having a first sealed evacuated insulating space therebetween and a current carrier configured to give rise to inductive heating. Also provided are methods of utilizing the disclosed thermally insulated modules in a variety of applications, including additive manufacturing and other applications.

### RELATED APPLICATIONS

The present application claims priority to and the benefit of U.S. Patent Application No. 62/658,022, “Thermally-Insulted Modules And Related Methods” (filed Apr. 16, 2018); U.S. Patent Application No. 62/773,816, “Joint Configurations” (filed Nov. 30, 2018); U.S. Patent Application No. 62/811,217, “Joint Configurations” (filed Feb. 27, 2019); and U.S. Patent Application No. 62/825,123, “Joint Configurations” (filed Mar. 28, 2019), which applications are incorporated herein by reference in their entireties for any and all purposes.

### TECHNICAL FIELD

The present disclosure relates to the field of thermal insulation components and to the field of induction heaters.

### BACKGROUND

In many applications—including, e.g., additive manufacturing—there is a need to heat a working material while minimizing excess heat emitted to the environment exterior to the working material. In other applications, there is a need to heat a working material while the module used to heat the working material maintains a relatively cool exterior. Accordingly, there is a long-felt need in the art for thermally-insulated modules that allow for heating of working material while maintaining some degree of thermal insulation of the heated working material.

### SUMMARY

In meeting the described long-felt needs, the present disclosure provides insulated modules that are suitable for use in a variety of applications, including such high-performance applications as additive manufacturing and materials processing. The disclosed modules allow for, inter alia, controllable heating of a working material while also thermally insulating that working material.

In one aspect, the present disclosure provides insulating modules, comprising: a nonconducting first shell; a conducting first component, the first shell being disposed about the first component, the first shell comprising a sealed evacuated insulating space, (b) the first shell and first component having a first sealed evacuated insulating space therebetween, the first component comprising a sealed evacuated insulating space, or any one or more of (a), (b), and (c); and a current carrier configured to give rise to inductive heating.

Also provided are insulating modules, comprising: a conducting first shell; a non-conducting first component, the first shell being disposed about the first component, the first shell comprising a sealed evacuated insulating space, (b) the first shell and first component having a first sealed evacuated insulating space therebetween, the first component comprising a sealed evacuated insulating space, or any one or more of (a), (b), and (c); and a current carrier configured to give rise to inductive heating.

Further provided are insulating modules, comprising: a non-conducting first shell; a non-conducting first component, the first shell being disposed about the first component, the first shell comprising a sealed evacuated insulating space, (b) the first shell and first component having a first sealed evacuated insulating space therebetween, the first component comprising a sealed evacuated insulating space, or any one or more of (a), (b), and (c); and a current carrier configured to give rise to inductive heating.

Further provided are methods, comprising: operating the current carrier of an insulating module according to the present disclosure so as to increase, by inductive heating, the temperature of a working material disposed within the inner shell of the insulating module.

Additionally provided are insulating modules, comprising: a first shell that comprises a material sensitive to inductive heating, the first shell having a first sealed evacuated insulating space therein; and a current carrier configured to give rise to inductive heating of the material sensitive to inductive heating.

Further disclosed are insulating modules, comprising: a first shell, the first shell comprising a sealed evacuated insulating space; a first component, the first component being disposed within the first shell and the first component comprising a material that is sensitive to inductive heating, the first component being disposed within the first shell, the first component being configured to receive a consumable; an induction heating coil, the induction heating coil being configured to give rise to inductive heating of the first component.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1A provides an illustrative embodiment of the disclosed technology;

FIG. 1B provides an illustrative embodiment of the disclosed technology;

FIG. 1C provides an illustrative embodiment of the disclosed technology;

FIG. 2A provides an illustrative embodiment of the disclosed technology;

FIG. 2B provides an illustrative embodiment of the disclosed technology;

FIG. 2C provides an illustrative embodiment of the disclosed technology;

FIG. 3A provides an illustrative embodiment of the disclosed technology;

FIG. 3B provides an illustrative embodiment of the disclosed technology;

FIG. 3C provides an illustrative embodiment of the disclosed technology;

FIG. 4 provides an illustrative embodiment of the disclosed technology;

FIG. 5 provides an illustrative embodiment of the disclosed technology;

FIG. 6 provides an illustrative embodiment of the disclosed technology; and

FIG. 7 provides an illustrative embodiment of the disclosed technology.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B.

As used herein, “sensitive to” can also mean “susceptible to”.

As explained in U.S. Pat. Nos. 7,681,299 and 7,374,063 (incorporated herein by reference in their entireties for any and all purposes), the geometry of an insulating space can be such that it guides gas molecules within the space toward a vent or other exit from the space. The width of the vacuum insulating space need not be not uniform throughout the length of the space. The space can include an angled portion such that one surface that defines the space converges toward another surface that defines the space. An insulating space can include a material (e.g., a ceramic thread, a ceramic ribbon, a ceramic ribbon) that reduces or eliminates direct contact between the walls between which the insulating space is formed.

As a result, the distance separating the surfaces can vary adjacent the vent such the distance is at a minimum adjacent the location at which the vent communicates with the vacuum space. The interaction between gas molecules and the variable-distance portion during conditions of low molecule concentration serves to direct the gas molecules toward the vent.

The molecule-guiding geometry of the space provides for a deeper vacuum to be sealed within the space than that which is imposed on the exterior of the structure to evacuate the space. This somewhat counterintuitive result of deeper vacuum within the space is achieved because the geometry of the present invention significantly increases the probability that a gas molecule will leave the space rather than enter. In effect, the geometry of the insulating space functions like a check valve to facilitate free passage of gas molecules in one direction (via the exit pathway defined by vent) while blocking passage in the opposite direction.

Another benefit associated with the deeper vacuums provided by the geometry of insulating space is that it is achievable without the need for a getter material within the evacuated space. The ability to develop such deep vacuums without a getter material provides for deeper vacuums in devices of miniature scale and devices having insulating spaces of narrow width where space constraints would limit the use of a getter material.

Other vacuum-enhancing features can also be included, such as low-emissivity coatings on the surfaces that define the vacuum space. The reflective surfaces of such coatings, generally known in the art, tend to reflect heat-transferring rays of radiant energy. Limiting passage of the radiant energy through the coated surface enhances the insulating effect of the vacuum space.

In some embodiments, an article can comprise first and second walls spaced at a distance to define an insulating space therebetween and a vent communicating with the insulating space to provide an exit pathway for gas molecules from the insulating space. The vent is sealable for maintaining a vacuum within the insulating space following evacuation of gas molecules through the vent.

The distance between the first and second walls is variable in a portion of the insulating space adjacent the vent such that gas molecules within the insulating space are directed towards the vent during evacuation of the insulating space. The direction of the gas molecules towards the vent imparts to the gas molecules a greater probability of egress than ingress with respect to the insulating space, thereby providing a deeper vacuum without requiring a getter material in the insulating space.

The construction of structures having gas molecule guiding geometry according to the present invention is not limited to any particular category of materials. Suitable materials for forming structures incorporating insulating spaces according to the present invention include, for example, metals, ceramics, metalloids, or combinations thereof

The convergence of the space provides guidance of molecules in the following manner. When the gas molecule concentration becomes sufficiently low during evacuation of the space such that structure geometry becomes a first order effect, the converging walls of the variable distance portion of the space channel gas molecules in the space toward the vent.

The geometry of the converging wall portion of the vacuum space functions like a check valve or diode because the probability that a gas molecule will leave the space, rather than enter, is greatly increased.

The effect that the molecule-guiding geometry of structure has on the relative probabilities of molecule egress versus entry can be understood by analogizing the converging-wall portion of the vacuum space to a funnel that is confronting a flow of particles.

Depending on the orientation of the funnel with respect to the particle flow, the number of particles passing through the funnel would vary greatly. It is clear that a greater number of particles will pass through the funnel when the funnel is oriented such that the particle flow first contacts the converging surfaces of the funnel inlet rather than the funnel outlet.

Various examples of devices incorporating a converging wall exit geometry for an insulating space to guide gas particles from the space like a funnel are provided herein. It should be understood that the gas guiding geometry of the invention is not limited to a converging-wall funneling construction and may, instead, utilize other forms of gas molecule guiding geometries.

Some exemplary vacuum-insulated spaces (and related techniques for forming and using such spaces) can be found in, e.g., PCT/US2017/020651; PCT/US2017/061529; PCT/US2017/061558; PCT/US2017/061540; and United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all incorporated herein by reference in their entireties for any and all purposes. Such a space can be termed an Insulon™ space. It should be understood, however, that the foregoing constructions are illustrative only and that the disclosed technology need not necessarily be made according to any of the foregoing constructions.

### Figures

Provided here is additional detail concerning the attached, non-limiting figures.

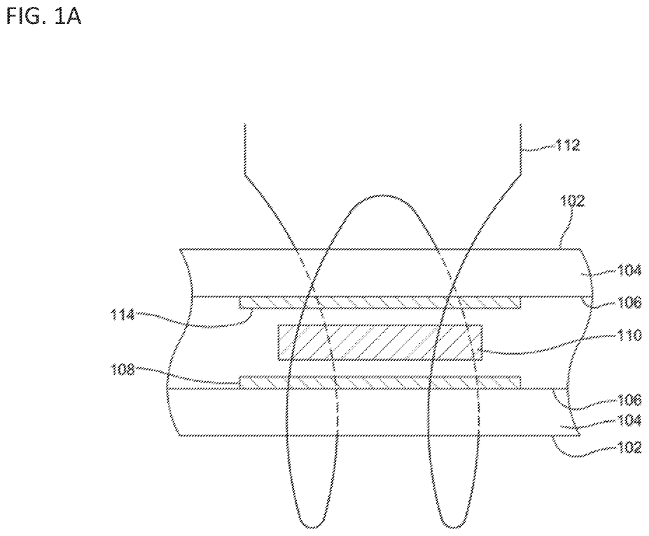

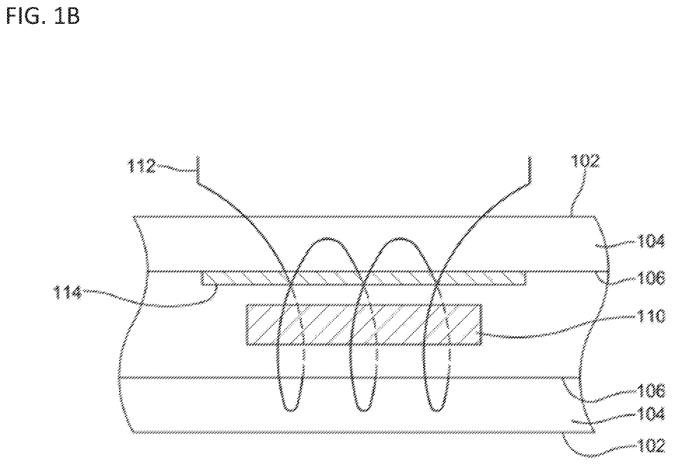

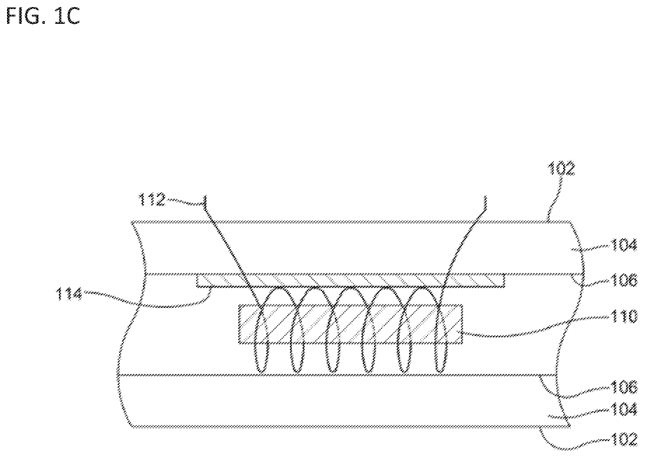

FIG. 1A provides a non-limiting, cutaway illustration of an article according to the present disclosure. As shown in FIG. 1A, an insulating module can include a first shell 102. A module can further include a first component 106. As shown, first component 106 can be a tube, but this is not a requirement, as first component 106 can be solid, e.g., be cylindrical. A sealed, evacuated insulating space 104 can be disposed between first shell 102 and first component 106. Example sealed, evacuated insulating spaces (and related techniques for forming and using such spaces) can be found in, e.g., PCT/US2017/020651; PCT/US2017/061529; PCT/US2017/061558; PCT/US2017/061540; and United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all of which are incorporated herein by reference in their entireties for any and all purposes.

A module can also include an amount of working material 110. Working material 110 can be heat-sensitive, e.g., material 110 can undergo a phase change (e.g., from solid to liquid, from solid to vapor, from solid to smoke, and the like) upon exposure to heating. Working material 110 can be a solid, but can also be semisolid. Working material 110 can be heated so as to liquefy, as an example. Alternatively, working material 110 can be heated so as to vaporize or smoke. Working material 110 can be combusted, but can also be heated without combustion, e.g., in a heat-not-burn fashion.

Although not shown, a module according to the present disclosure can include one or more sensors. A sensor can be, for example, a temperature sensor, a pressure sensor, a humidity sensor. Other sensors besides the foregoing are also contemplated. As an example, a module according to the present disclosure can include a temperature sensor that monitors a temperate within first component 106. A temperature sensor can also be configured to monitor a temperature in the environment surrounding working material 110. A temperature sensor can also be configured to monitor a temperature of one or both of elements 114 and 118 as shown in FIG. 1A, which elements are described further herein.

Working material 110 can also comprise pores, channels, or other voids therein. Additionally, working material 110 can be a single “unibody” piece of working material such as an ingot or wire, but can also be multiple portions of material, e.g., individual segments, particulates, flakes, and the like. Working material 110 can be a consumable cartridge or insert.

Polymeric materials are considered suitable working materials, but there is no limitation on the working material that can be disposed within the module. A working material can comprise a metal, a wax, and the like. The working material can include a material that is sensitive to inductive heating.

Modules according to the present disclosure can also include a current collector 112. As shown, a current collector can be present as a coil, and can, in some embodiments, be disposed about the first shell 102, as shown in exemplary FIG. 1A. Without being bound to any particular embodiment, a current collector can be configured as an induction coil that induces inductive heating within (or outside of) a module according to the present disclosure. A module can include one or more portions of magnetic shielding; such shielding can be used to shield one or more elements of the module from magnetic and/or electric fields or current. It should be understood that current collector 112 need not be present in coil form. In some embodiments, current collector 112 can be of the form of one or more wires that are arranged opposite one another such that alternating or sequential application of current through the wires gives rise to inductive heating of material (e.g., working material, a metal element that is used as a heating material) that is disposed between the wires.

A coiled current collector is considered especially suitable, as such a configuration can be used to effect inductive heating of a working material disposed within the coil. Without being bound to any particular theory, a power supply (e.g., a solid state RF) can sent a current through the current collector. The frequency of the current can be constant or varied. Frequencies in the range of from about 5 to about 30 kHz can be useful with comparatively thick working materials (e.g., a rod having a diameter of 50 mm or greater). Frequencies in the range of about 100 to about 400 kHz can be useful with comparatively smaller workpieces or where relatively shallow heat penetration is desirable. Frequencies of 400 kHz or higher can be useful with especially small workpieces.

A current collector can be cooled (e.g., air-cooled or even liquid-cooled). A current collector can be a solid (i.e., not hollow), but can also be hollow in configuration.

A working material can be placed within the current collector. The current collector serves as the transformer primary and working material (to be heated) becomes a short circuit secondary. Circulating eddy currents are then induced within the working material. The eddy currents can flow against the electrical resistivity of the working material, which in turn creates heat without physical contact between the current collector and the working material.

Additional heat can be produced within magnetic parts through hysteresis—internal friction that is created when magnetic parts pass through the current collector. Magnetic working materials naturally offer electrical resistance to the rapidly changing magnetic fields within the inductor. This resistance produces internal friction that in turn produces heat. In the process of heating the working material, there need be no contact between the inductor and the working material. The working material to be heated can be located in a setting isolated from the power supply.

A module can also include a first element 108, though it should be understood that such an element is optional. Such a first element can be metallic, and can be disposed within the first component 106. The first element can be present as a wire, a ribbon, a coil, a layer, a coating, or in essentially any form. In some embodiments, first element 108 can be a sleeve or ring that extends at partially circumferentially around the lumen of the first component 106. In some embodiments, the first element is inductively heated by the current collector.

In some embodiments, a module can include a second element 114. First element 108 and second element 114 can be formed of the same material or of different materials. In some embodiments, one or both of the first and second elements are inductively heated by the current collector. As an example, one or both of first element 108 and 114 can be formed of a metal or other material that can be inductively heated.

A module can be configured such that the material 110 contacts the first element 108 and/or second element 114, though this is not a requirement. As one example, working material 110 can be heated via element 108 and/or 114 via convective and/or radiative heating. In some embodiments, first component 106 is inductively heated by the current collector 112. In some embodiments, the working material 110 is capable of being inductively heated or comprises a component that is capable (e.g., a metal) of being inductively heated.

As shown, first component 106 can define a lumen (not labeled) within. In the example embodiment shown in FIG. 1A, working material 110 is disposed within the lumen of first component 106. Working material 110 can be slidably introduced into a module, e.g., in the manner of a cartridge or other insert that is inserted into the module.

It should be understood, however, that first element 108 and second element 114 are optional and are not required. As an example, shell 102 can be formed of a ceramic (or other material that is not sensitive to inductive heating), and first component 106 can be formed of a material (e.g., a metal) that is sensitive to inductive heating. In this way, operation of current collector 112 gives rise to inductive heating of first component 106, which in turn heats working material 110. In some embodiments, both shell 102 and first component 116 are non-sensitive to inductive heating, and one or both of first element 108 and second element 114 (if present) are inductively heated by operation of current collector 112. (In such embodiments, one or both of first element 108 and 114 are metal or other material that is sensitive to inductive heating.)

In some embodiments, both shell 102 and first component 106 are formed of material that is sensitive to inductive heating. (It is not a requirement that shell 102 and first component 106 be formed of the same material.) In some embodiments, shell 102 is formed of a material that is sensitive to inductive heating, and first component 106 is formed of a material that is not sensitive to inductive heating. As described elsewhere herein, shell 102 can be formed of a material that is not sensitive to inductive heating and first component 106 is formed of a material that is sensitive to inductive heating. (Shell 102 and first component 106 can also be comprised such that shell 102 is more sensitive to inductive heating than first component 106; shell 102 and first component 106 can also be comprise such that first component 106 is more sensitive to inductive heating than shell 102.)

Although working material 110 is shown in FIG. 1A as being within the lumen of first component 106, this is not a requirement, as the working material 110 can be disposed exterior to shell 102, e.g., as a ring, tube, or other form that at least partially encircles shell 102. In some such embodiments, shell 102 can be formed of a material that is sensitive to inductive heating. In this way, a current collector can be used to effect inductive heating of shell 102, which in turn heats a working material that is disposed about shell 102.

In some such embodiments, an element (e.g., a metallic ring, coating, or layer) is disposed about shell 102. Such an element can be sensitive to inductive heating. In this way, a current collector can be used to effect inductive heating of the element (and, depending on the material of shell 102, of shell 102), which in turn heats a working material that is disposed about shell 102.

In some embodiments, a module can operate so as to effect heating of material disposed exterior to shell 102 and material that is disposed within shell 102. By taking advantage of the evacuated space 104 between shell 102 and first component 106, a module according to the present disclosure can give rise to heating different materials (interior to shell 102 and exterior to shell 102) at different heating levels. For example (and by reference to FIG. 1A), a material disposed exterior to shell 102 can be heated inductively by shell 102 (and/or by an element disposed exterior to shell 102) at a first level of heating, and a material disposed within first component 106 at a second level of heating, as the material exterior to shell 102 is thermally insulated (by way of evacuated space 104) from the material within first component 106.

A module according to the present disclosure can include (not shown) a receiving component (e.g., a holder) that receives working material 110 and maintains working material 110 in position within the module. The receiving component can maintain working material 110 at a distance from first component 106. Alternatively, the receiving component can be configured to maintain the working material about shell 102, e.g., when the working material is present as a sleeve or tube that at least partially encloses shell 102.

An alternative embodiment is shown in FIG. 1B. As shown in FIG. 1B, a module can include a first shell 102. A module can further include a first component 106. As shown, first component 106 can be a tube, but this is not a requirement, as first component 106 can be solid, e.g., be cylindrical. A sealed, evacuated insulating space 104 can be disposed between first shell 102 and first component 106.

A module can also include an amount of working material 110. Working material 10 can be heat-sensitive, e.g., working material 110 can undergo a phase change upon exposure to a certain temperature. Working material 110 can be a solid, but can also be semisolid.

Working material 110 can also comprise pores, channels, or other voids therein. Additionally, working material 110 can be a single “unibody” piece of working material such as an ingot or wire, but can also be multiple portions of working material, e.g., individual segments, particulates, flakes, and the like. Polymeric working materials are considered especially suitable, but there is no limitation on the working material that can be disposed within the module.

Modules according to the present disclosure can also include a current collector 12. As shown, a current collector can be present as a coil, and can, in some embodiments, be disposed within the insulating space 104, as shown in example FIG. 1B. Without being bound to any particular embodiment, a current collector can be configured as an induction coil that induces inductive heating within (or outside of) a module according to the present disclosure.

A module can also include an element 114, though such an element is optional. Such a first element can be metallic, and can be disposed within the first component 106. The first element can be present as a wire, a ribbon, a coil, or in essentially any form. In some embodiments, the first element is inductively heated by the current collector.

In some embodiments, the element is inductively heated by the current collector. A module can be configured such that the working material 110 contacts the element 114, though this is not a requirement. In some embodiments, first component 106 is inductively heated by the current collector 112. In some embodiments, the working material 110 is capable of being inductively heated or comprises a component that is capable (e.g., a metal) of being inductively heated.

An further alternative embodiment is shown in FIG. 1C. As shown in FIG. 1C, a module can include a first shell 102. A module can further include a first component 106. As shown, first component 106 can be a tube, but this is not a requirement, as first component 106 can be solid, e.g., be cylindrical. A sealed, evacuated insulating space 104 can be disposed between first shell 102 and first component 106.

A module can also include an amount of working material 110. Working material 10 can be heat-sensitive, e.g., working material 110 can undergo a phase change upon exposure to a certain temperature.

Working material 110 can be a solid, but can also be semisolid. Material 110 can also comprise pores, channels, or other voids therein. Additionally, working material 110 can be a single “unibody” piece of working material such as an ingot or wire, but can also be multiple portions of working material, e.g., individual segments, particulates, flakes, and the like. Polymeric working materials are considered especially suitable, but there is no limitation on the working material that can be disposed within the module.

Modules according to the present disclosure can also include a current collector 112. As shown, a current collector can be present as a coil, and can, in some embodiments, be disposed within the first component 106. Without being bound to any particular embodiment, a current collector can be configured as an induction coil that induces inductive heating within (or outside of) a module according to the present disclosure.

A module can also include an element 114, though such an element is optional. Such an element can be metallic, and can be disposed within the first component 106. (For convenience, FIG. 1B and FIG. 1C each show only one element disposed within the first component. It should be understood, however, that a module according to the present disclosure can include zero, one, two, or more such elements.)

The first element can be present as a wire, a ribbon, a coil, or in essentially any form. In some embodiments, the first element is inductively heated by the current collector.

In some embodiments, the element is inductively heated by the current collector. A module can be configured such that the working material 110 contacts the element 114, though this is not a requirement. In some embodiments, first component 106 is inductively heated by the current collector 112. In some embodiments, the working material 110 is capable of being inductively heated or comprises a component that is capable (e.g., a metal) of being inductively heated. As shown in FIG. 1C, current collector 112 can be disposed within a lumen of first component 106.

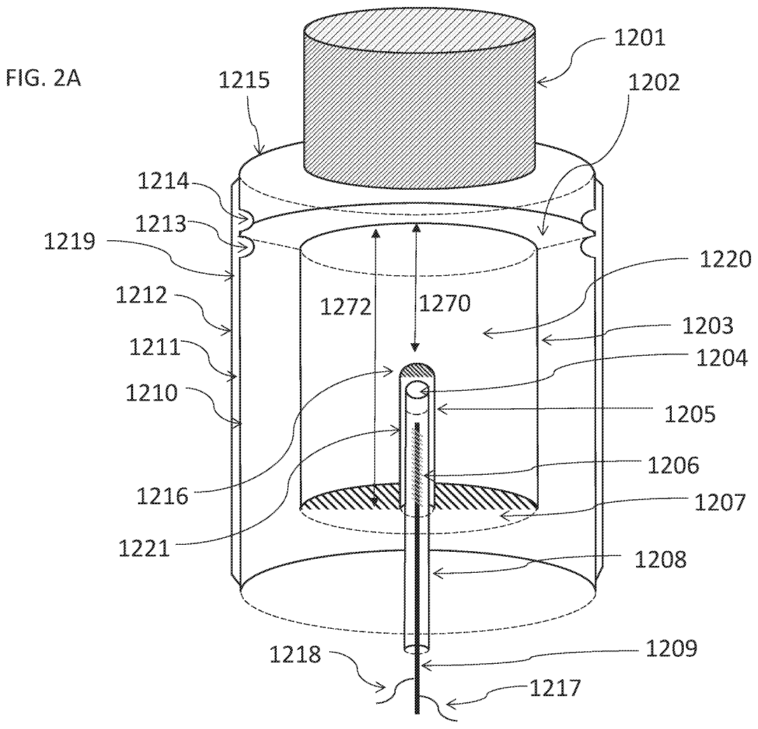

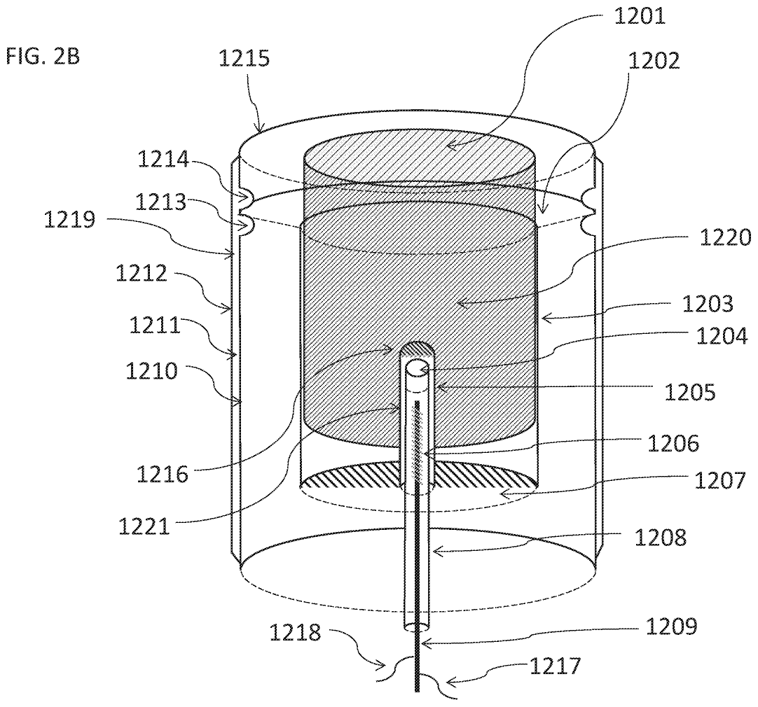

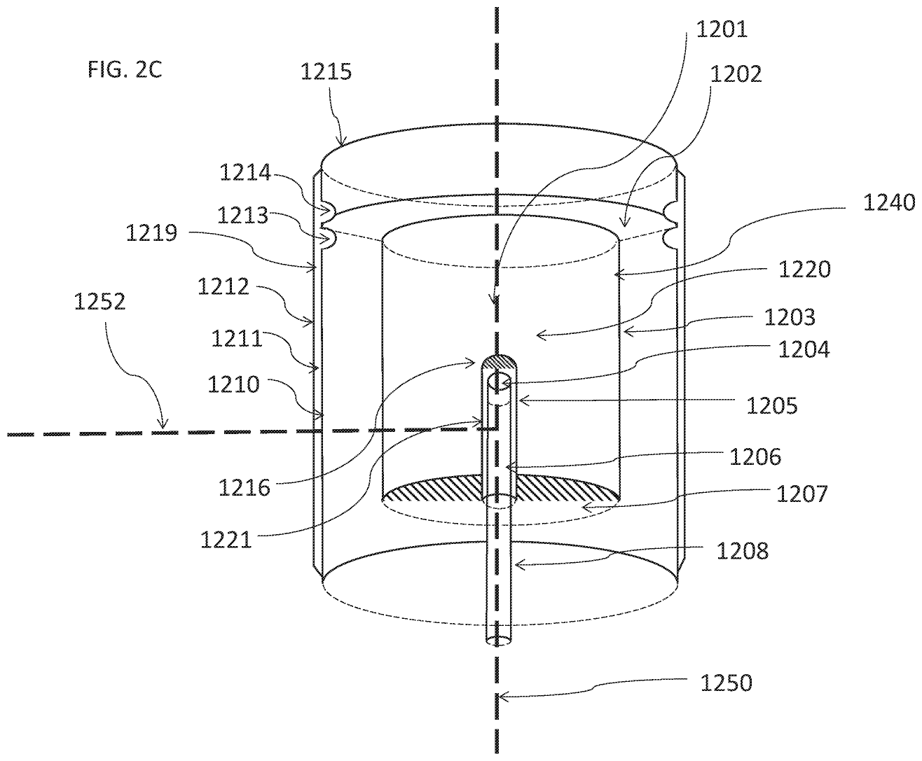

Another embodiment is provided in non-limiting FIG. 2A. As shown in that figure, a module according to the present disclosure can include a first component 1203. First component 1203 can be formed from a material that is sensitive to induction heating, e.g., a ferrous metal or a material that comprises a ferrous metal.

First component 1203 can be present as, e.g., a tube, a cylinder, a can, or other shapes. First component 1203 can include a feature 1202 (e.g., a flange) that is used to locate first component 1203 within the module. As shown in non-limiting FIG. 2, flange 1202 is engaged with locating features 1212 and 1213 of the module. Locating features can be, e.g., flanges, protrusions, ridges, slots, tabs, grooves, and the like. First component 1203 can include one or more wrinkles, corrugations, or other features that can expand or contract in response to a change in temperature. Without being bound to any particular theory, such features can accommodate (e.g, via expansion) stresses in the first component that results from temperature change in order to reduce or even eliminate forces that the first component might otherwise exert against other elements of the module as the first component is heated and/or cools.

First component 1203 can be disposed within first shell 1219. First shell 1219 can have an outer wall 1212 and inner wall 1210. Though not a requirement, one can arrange the components so as to minimize the distance between first component 1203 and inner wall 1210. First shell 1219 can be tubular in configuration, but can also be formed as a can, having a bottom, or even a bottom and top. First shell 1219 can be circular in cross-section, but this is not a requirement, as first shell 1219 can be of other (e.g., polygonal, ovoid) cross-sections.

It should also be understood that one or both of outer wall 1212 and inner wall 1210 of first shell 1219 can comprise a material (e.g., a ferrous material) that is sensitive to induction heating. In some embodiments, e.g., those where a portion of first shell 1219 is sensitive to induction heating, first component 1203 can be optional.

A sealed evacuated space 1211 can be defined between outer wall 1212 and inner wall 1210 of first shell 1219. Suitable such spaces are described elsewhere herein. Inner wall 1210 can be formed from a material that is non-ferrous and is not sensitive to inductive heating. Likewise, outer wall 1212 can be formed from a material that is non-ferrous and is not sensitive to inductive heating. Ceramic materials can be used as such non-ferrous materials. First shell 1219 can include an upper rim 1215.

As shown in FIG. 2A, the module can include a cup 1205, which cup can be formed in first component 1203. As shown, cup 1205 can be formed as a depression (which can also be termed a pouch or invagination) in portion of first component 1203, e.g., in the bottom of first component 1203 when first component 1203 is in the form of a can with a bottom. The cup can have an end 1216. End 1216 can include a point, ridge, or other profile that is useful in penetrating into a material. A consumable used in conjunction with the disclosed modules can include a recess or other feature into which end 1216 can fit. End 1216 can be located at a distance from an end of first component 1203. As an example, end 1216 can be located at a distance relative to an end of first component 1203 as measured along a central axis of first component 1203 that is coaxial with cup 1205. As shown in FIG. 2, cup 1205 can be connected to a wall of first component 1203, e.g., via surface 1207 of first component 1203; in some embodiments, cup 1205 is part of first component 1205. In some embodiments, first component 1203 is formed of a single piece of material, which piece of material also defines cup 1205. Although not shown, first component 1203 can include one or more apertures formed therein.

Also as shown, first component 1203 can define an interior volume 1220. The interior volume 1220 can be defined by the interior surface of first component 1203. As shown, the interior surface of the exemplary first component 1203 defined by the interior surface 1240 of first component 1203, as well as by the surface 1221 of cup 1205. Interior volume 1220 can be used to at least partially contain a working material, e.g., a consumable. As shown, interior volume can define a height 1272.

A module can include an induction coil 1206. A heating coil can be in electronic communication with one or more leads; example leads 1217 and 1218 are shown in FIG. 2. Induction coil 1206 can be at least partially enclosed within coil container 1208. Coil container 1208 can comprise inner and outer walls that define a sealed evacuated space (not labeled) therebetween. Coil container 1208 can be tubular in configuration, but can also be a can in configuration, with tubular walls and a top, shown as 1204 in FIG. 2A. Top 1204 can also define a sealed evacuated space. A module can also include a flange, jig, or other component configured to maintain the induction coil in position.

Coil container 1208 can comprise a ceramic material, and can be magnetically transparent. In this way, current in induction coil 1206 can effect heating of cup 1205, while reducing the amount of loss as the magnetic field crosses coil container 1208. Coil container 1208 can comprise ceramic walls that define a sealed evacuated space therebetween; suitable such spaces are described elsewhere herein. A sealed, evacuated space can be present between cup 1205 and coil container 1208, in some embodiments.

As shown in FIG. 2B, consumable 1201 can be inserted into the module, and can be at least partially contained within interior volume 1220. End 1216 can extend into consumable 1201. As described elsewhere herein, end 1216 can be configured as a point, a ridge, a crimp, an edge, or other modality configured to penetrate into consumable 1201. Consumable 1201 can comprise a solid, but can also comprise a fluid, e.g., a liquid or even a gas. A module can also include a flange, jig, collar, or other element configured to maintain the consumable in place. A module can include (not shown) an opening (and/or a closure) into which a consumable can be introduced and/or retrieved. A closure can be a thermal insulator; as one example, the closure can include walls with a sealed evacuated space defined therebetween. (Suitable such spaces are described elsewhere herein.) A closure can be formed of a non-ferrous material that is not sensitive to inductive heating.

As shown, end 1216 can be at a distance 1270 from an end of interior volume 1220. The ratio of distance 1270 to height 1272 can be from, e.g., 1:1000 to 1:1. In some embodiments, end 1216 can extend beyond interior volume 1220.

In operation, induction coil 1206 can be operated so as to give rise to heating of first component 1203, which in turn gives rise to heating of consumable 1201. By having induction coil 1206 effectively located within consumable 1201, a user can heat consumable 1201 from inside (via induction heating effected in cup 1205) and also from outside (via induction heating of portions of first component 1203 that contact or face consumable 1201). This configuration thus provides for efficient heating of consumable 1201. The disclosed configuration also provides for heating of the consumable (via inductive heating) while maintaining thermal insulation (via the insulating capability of first shell 1219) between the heated consumable and the user.

The present configuration also acts to thermally insulate coil 1216 from the inductively heated cup 1205 and the first component 1203. This thermal insulation is accomplished by the thermal insulating capability of coil container 1208. As described elsewhere herein, a module can be operated to effect combustion of the consumable 1201, but can also be operated so as to heat the consumable without burning the consumable.

The disclosed modules (and any document cited herein) can also include an additional amount of heat transfer material (e.g., metal, carbon black, graphite (including pyrolytic graphite), and the like). Such heat transfer material can be used where improved heat transfer is advantageous; e.g., along surface 1240 of first component 1203 as shown in FIG. 2A, along surface 1221, or in other locations.

By reference to FIG. 2A, further embodiments are described. As one example, first component 1203 need not necessarily be present. In such embodiments, inner surface 1210 of first shell 1219 can comprise a material (e.g., a ferrous metal) that is sensitive to inductive heating. In such embodiments, induction coil 1206 can be positioned so as to effect inductive heating of inner surface 1210 of first shell 1219.

In some embodiments, (not shown), coil 1206 can be present on or integrated into first component 1203 or even on or into first shell 1219. Coil 1206 can be present as a coiled, round wire, but can also be present as a coiled tape or flattened conductor. Coil 1206 can be disposed on or even integrated to surface 1207. As an example, first component 1203 can be present as a “can”, and coil 1206 can be present as on the “bottom” of the can. In some embodiments, first component 1203 does not include cup 1205; e.g., when first component is present as a can with a flat bottom portion that does not pouch or invaginate inward. Coil 1026 can also be disposed about first component 1203; in some embodiments, coil 1206 is not disposed within coil container 1218.

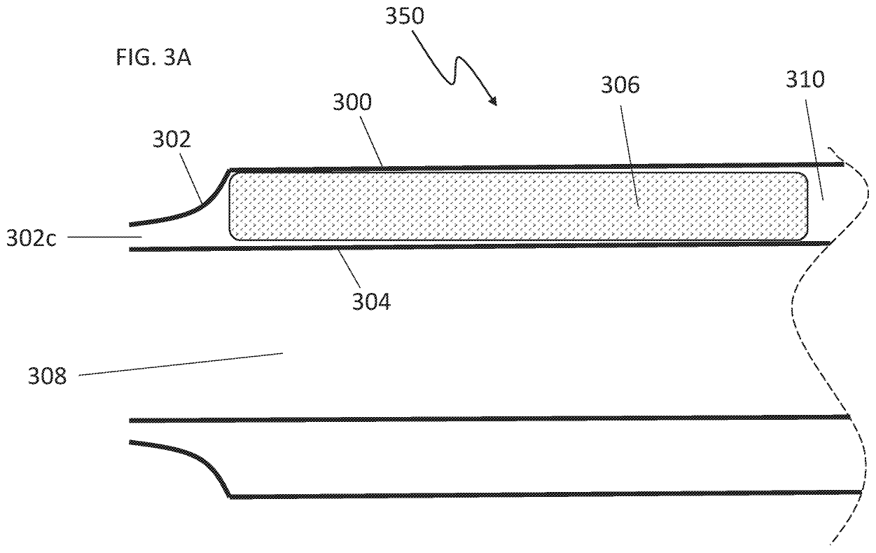

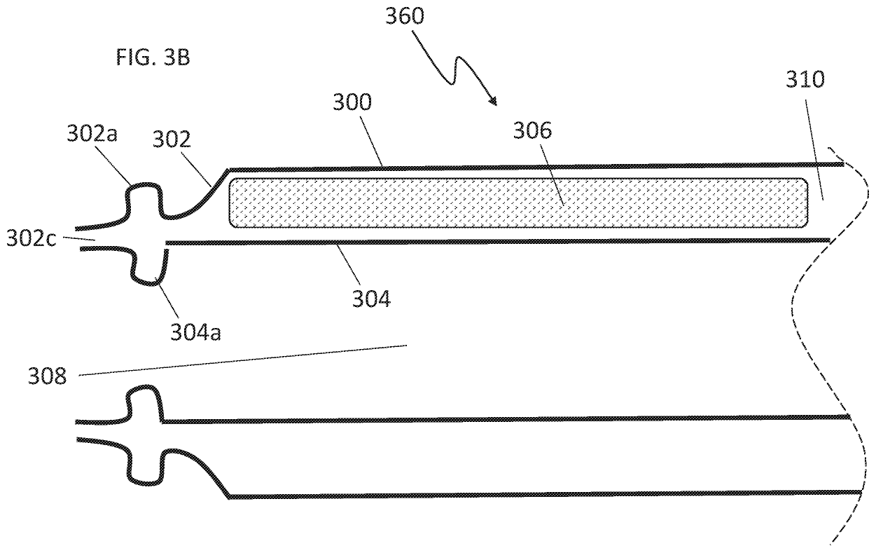

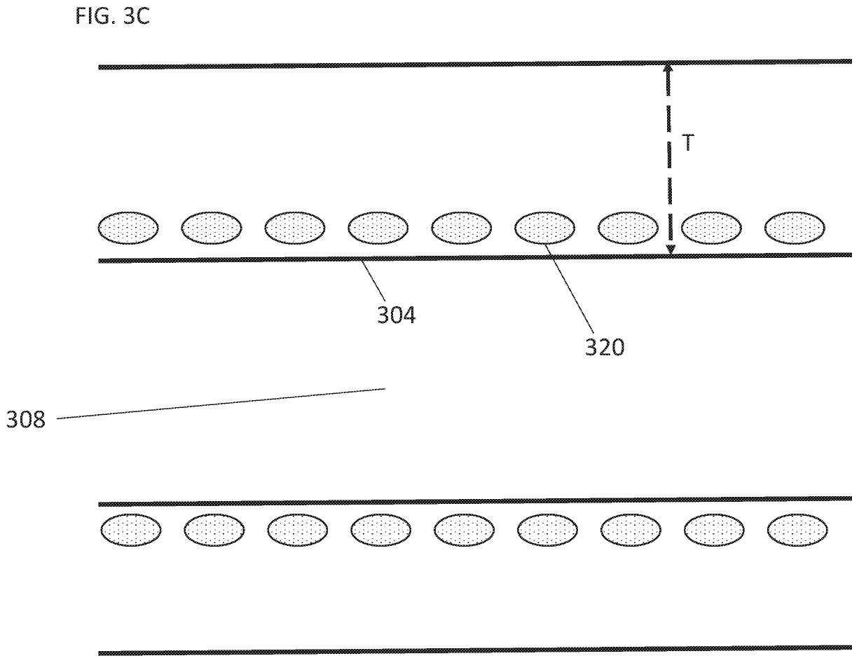

FIG. 3A illustrates a component configuration according to the present disclosure. As shown, a device 350 can comprise a first wall 300, which first wall can also be termed a “shell.” First wall 300 can be cylindrical, although this is not a rule or requirement. First wall 300 can comprise a metal (or a mixture/alloy of metals), though this is not a requirement. First wall 300 can also comprise one or more ceramic materials.

First wall 300 can be susceptible to inductive heating. As an example, an induction heating coil (not shown in FIG. 3A) can be positioned so as to, when operated, give rise to inductive heating of first wall 300. This can be done to, e.g., heat the outer surface of the component. Lumen 308 can be sealed at one or both ends. Lumen 308 can be used to carry a fluid, e.g., a cooling fluid used to cool an inductive or other heating coil.

Component 350 can also include second wall 304. Second wall 304 can comprise a metal (or a mixture/alloy of metals), though this is not a requirement. Second wall 304 can also comprise one or more ceramic materials. Second wall 304 can also comprise a material (e.g., metal) that is susceptible to induction heating, although this is not a requirement. Second wall 304 can thus include two or more materials wherein one of the materials is susceptible to inductive heating. The susceptible material can be (as described elsewhere herein) be mixed into the bulk material of second wall 304, but can also be deposited in layers or bands within the bulk material of second wall 304.

As shown, second wall 304 can define a lumen 308 within, e.g., when second wall 304 is cylindrical in configuration. The lumen can be configured to allow a fluid to pass therethrough (e.g., a heated fluid, a cooled fluid). The lumen can also be configured to receive an element, e.g., a consumable component such as a cartridge, packet, ampule, or the like. Component 350 can include one or more features (e.g., a ridge, a recess) disposed within lumen 308 so as to engage with an article that is inserted into lumen 308. A material that is susceptible to induction heating can also be disposed on (or in) second wall 304, e.g., in the form of a coating or film. Such a material can be present in discrete portions (e.g., dots, strips), but can also be present in a single portion, e.g., a helical coil or even a band. A component can also include (not shown) a susceptible material elsewhere, e.g., located within lumen 308 and maintained in position there by a bracket or other fixture.

As shown in FIG. 3A, first wall 300 and second wall 304 can define insulating space 310 therebetween. The insulating space can be at atmospheric pressure, but can also be evacuated.

First wall 300 can optionally include a converging region 302. Converging region 302 can comprise a curved or bent portion, although this is not a requirement. Converging region 302 can also comprise a straight portion. As shown, converging region can converge towards second wall 304 so as to form vent 302c, which is in fluid communication with insulating region 310. Vent 302c enhances the evacuation of insulating region 310, as described elsewhere herein, e.g., in U.S. Pat. No. 7,374,063. It should be understood that first wall 300 need not include a converging portion 302. It should also be understood that second wall 304 can include a portion (not shown) that flares toward first wall 300, i.e., that converges toward first wall 300. In some embodiments, first wall 300 can include a portion that converges toward second wall 304, and second wall 304 can include a portion that converges toward first wall 300. It should be understood that the configuration shown in FIG. 3A is illustrative only and is not the exclusive manner of forming a sealed insulating space between two walls. A sealed insulating space can also be formed by using one or more caps. Exemplary such embodiments are provided in U.S. patent applications 62/773,816 (filed Nov. 30, 2018); 62/811,217 (filed Feb. 27, 2019); and 62/825,123 (filed Mar. 28, 2019), all of which are incorporated herein by reference in their entireties for any and all purposes.

As shown, component 350 can also include support material 306. Support material 306 can be used to support insulating space 310, e.g., in the manner of a scaffold. It should be understood that support material 306 can be of virtually any shape. As shown in FIG. 3A, support material 306 has a rectangular cross-section. This is not a requirement, however, as support material 306 can have any cross-section that the user may desire. As an example, support material 306 can have a shape that (not shown in FIG. 3A) includes a narrowed portion that at least partially fills or fits into vent 302c.

Support material 306 can be a material that acts as a sacrificial material, e.g., a material that is at least partially eliminated during the formation of component 350. As but one example, support material 306 can be a metal foam that is at least partially vaporized during the formation of component 350. Support material 306 can also be used to at least partially seal insulating space 310. As an example of such sealing, support material 306 can be melted under conditions such that at least some of the melted support material flows at least partially seals vent 302c.

As another example, second wall 304 can comprise a fired ceramic material, and first wall 300 can (initially) comprise a green (i.e., unfired) ceramic material. Support material 306 can be disposed so as to support the formation of insulating space 310 when the green ceramic material of first wall 300 is fired. Support material 306 can be selected such that following the firing of (green ceramic) second wall 300, the support material melts/and or vaporizes, e.g., by application of a higher temperature than the temperature used to fire first wall 300.

FIG. 3B provides an alternative configuration for a component 360 according to the present disclosure. As shown, a device 360 can comprise a first wall 300, which first wall can also be termed a “shell.” First wall 300 can be cylindrical, although this is not a rule or requirement. First wall 300 can comprise a metal (or a mixture/alloy of metals), though this is not a requirement. First wall 300 can also comprise one or more ceramic materials.

Component 360 can also include second wall 304. Second wall 304 can comprise a metal (or a mixture/alloy of metals), though this is not a requirement. Second wall 304 can also comprise one or more ceramic materials. Second wall 304 can also comprise a material (e.g., metal) that is susceptible to induction heating, although this is not a requirement.

As shown, second wall 304 can define a lumen 308 within, e.g., when second wall 304 is cylindrical in configuration. The lumen can be configured to allow a fluid to pass therethrough (e.g., a heated fluid, a cooled fluid). The lumen can also be configured to receive an article, e.g., a consumable component such as a cartridge, packet, ampule, or the like. Component 360 can include one or more features (e.g., a ridge, a recess) disposed within lumen 308 so as to engage with an article that is inserted into lumen 308. A material that is susceptible to induction heating can also be disposed on second wall 304, e.g., in the form of a coating or film. Such a material can be present in discrete portions (e.g., dots, strips), but can also be present in a single portion, e.g., a helical coil or even a band.

As shown in FIG. 3A, first wall 300 and second wall 304 can define insulating space 310 therebetween. The insulating space can be at atmospheric pressure, but can also be evacuated.

First wall 300 can optionally include a converging region 302. Converging region 302 can comprise a curved or bent portion, although this is not a requirement. Converging region 302 can also comprise a straight portion. As shown, converging region can converge towards second wall 304 so as to form vent 302c, which is in fluid communication with insulating region 310. Vent 302c enhances the evacuation of insulating region 310, as described elsewhere herein, e.g., in U.S. Pat. No. 7,374,063. It should be understood that first wall 300 need not include a converging portion 302. It should also be understood that second wall 304 can include a portion (not shown) that flares toward first wall 300, i.e., that converges toward first wall 300. In some embodiments, first wall 300 can include a portion that converges toward second wall 304, and second wall 304 can include a portion that converges toward first wall 300.

As shown, first wall 300 can optionally include recess 302a, which can be in the form of a circumferential groove that runs around the circumference of first wall 300. Recess 302a can be used, e.g., to receive braze material that is used to seal insulating space 310. Similarly, second wall 304 can optionally include recess 304a. Recess 304a can be used, e.g., to receive braze material that is used to seal insulating space 310. Either, both, or neither of first wall 300 and second wall 304 can include a recess.

As shown, component 360 can also include support material 306. Support material 306 can be used to support insulating space 310, e.g., in the manner of a scaffold. It should be understood that support material 306 can be of virtually any shape. As shown in FIG. 3A, support material 306 has a rectangular cross-section. This is not a requirement, however, as support material 306 can have any cross-section that the user may desire. As an example, support material 306 can have a shape that (not shown in FIG. 3A) includes a narrowed portion that at least partially fills or fits into vent 302c.

Support material 306 can be a material that acts as a sacrificial material, e.g., a material that is at least partially eliminated during the formation of component 350. As but one example, support material 306 can be a metal foam that is at least partially vaporized during the formation of component 350. Support material 306 can also be used to at least partially seal insulating space 310. As an example of such sealing, support material 306 can be melted under conditions such that at least some of the melted support material flows at least partially seals vent 302c.

FIG. 3C provides a cutaway view of a configuration of second wall 304. As shown, second wall 304 defines a thickness T, and also defines a lumen 308. A material 320 that is susceptible to inductive heating (e.g., a metal) can be disposed within the thickness of second wall 304. As an example, second wall 304 may comprise a material (such as, e.g., a ceramic) that is not itself susceptible to inductive heating. Material 320 can be disposed within the thickness of the ceramic wall, however, such that application of a suitable field can effect heating of material 320, thereby effecting heating within lumen 308. Material 320 can be present as, e.g., particles, flakes, bands, strips, and the like. Material 320 can be present through only a portion (e.g., 1/20, 1/10, ⅕, ½) of the thickness T of second wall 304, though this is not a requirement. Material 320 can be encased entirely within the material of second wall 304, but this is not a requirement, as at least some of material 320 can be exposed to lumen 308 or even the non-lumen side of second wall 304. (The susceptible material may also be located in the element as well. Wall 304 may be present without wall 300 and space 310)

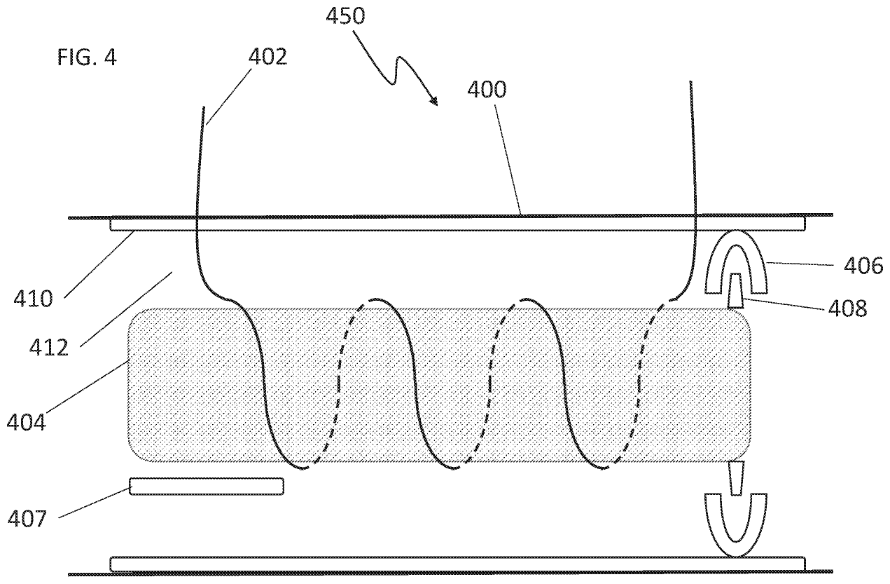

FIG. 4 provides another configuration of a component (450) according to the present disclosure. As shown, component 450 can include boundary 400.

Boundary 400 can comprise a single wall, e.g., a ceramic wall. It should be understood that as used herein, the term “ceramic” includes materials that are ceramic and also includes materials that are glass-ceramic materials, i.e., materials that comprise a crystalline phase and an amorphous phase. Some non-limiting examples of glass-ceramic materials are, e.g., the Li₂O×Al₂O₃×nSiO₂ system (LAS system), the MgO x Al₂O₃×nSiO₂ system (MAS system), and the ZnO×Al₂O₃×nSiO₂ system (ZAS system).

Boundary 400 can also comprise multiple walls, e.g., first and second walls spaced apart from one another so as to define a sealed insulated space therebetween. Boundary 400 can comprise a metal, but can also comprise a ceramic material. (Porous and non-porous ceramics are suitable.) As an example, boundary 400 can comprise two metal walls, arranged as concentric cylinders. Boundary 400 can also comprise, e.g., a single cylindrical ceramic wall. Boundary 400 can also comprise two or more ceramic walls. Thus, boundary 400 can define an insulation, which insulation can be an air gap, an evacuated volume, and the like. As one example, a boundary can comprise two walls that define a sealed, evacuated volume therebetween.

It should be understood, however, that a boundary need not be cylindrical in configuration. As an example, a boundary can be planar. A boundary can be curved, but need not be circular or cylindrical in form. A component according to the present disclosure can, in fact, comprise one, two, or even more boundaries. As one example, a component according to the present disclosure can comprise two boundaries, which boundaries can “sandwich” therebetween article 404.

The thickness of a wall of boundary 400 can depend on the needs of the user. As an example, a ceramic wall can have a thickness of less than about ⅛ of an inch (i.e., 0.31 cm).

Component 400 can also optionally include a material 410 that faces inward from boundary 400. Material 410 can be, e.g., a reflective material (such as a metal). Material 410 can also be a ceramic material. As one example, boundary 400 can comprise stainless steel, and material 410 can comprise a ceramic layer disposed on boundary 400. Without being bound to any particular configuration or theory, boundary 400 (and/or material 410) can comprise a ceramic portion that faces article 404. One advantage of such a configuration is that ceramic materials are comparatively easy to clean.

Component 450 can include coil 402, which coil can be operated as an induction coil and/or as a resistive heating coil, depending on the user's needs. As shown, induction coil 402 can be configured so as to extend into space 412 that is defined within boundary 400. Induction coil 402 can be configured such that article 404 can be disposed (e.g., via insertion) within at least a portion of induction coil 402. A component can include two or more coils. In one embodiment, a coil can be operated as an induction coil so as to effect heating of article 404 from within article 404 (e.g., where article 404 comprises a material therein or thereon that is susceptible to inductive heating). The coil can also be operated as a resistance heating coil so as to heat article 404 from the outside. In this manner, a user can effect inductive heating of article 404 from the inside out as well as resistive (or other) heating of article 404 from the outside in. The coil 402 can be used as a heating coil, e.g., at the same time it is working as an induction coil. Alternatively, the coil can be switched between an induction heating coil and a resistance heating coil and vice versa. One example of achieving this is to pass AC/DC current through the coil, depending on whether resistance heating or induction heating is desired.

Although coil 402 is shown as being disposed within space 412 that is defined within boundary 400, it should be understood that coil 402 can be disposed such that it is between two walls of boundary 400 or even located outside of boundary 400. In some embodiments, no portion of the coil is disposed within space 412 defined within boundary 400.

Article 404 can be a consumable, e.g., a source of vaporizable or even smokeable material, such as a mass of smokable material. (Such material can in solid, semi-solid, liquid, flakes, strings, mixed with an induction-susceptible material, or even in vapor form). A smokeable material includes materials that yield one or more volatilzed components when heated, e.g., a vapor. A smokeable material can contain tobacco (in any form, including reconstituted forms), nicotine, and the like.

Article 404 can be sized such that it is insertable within space 412, and also within coil 402. (Put another way, space 412 can be configured to receive article 404, which can comprise a smokeable or vaporizable material.) Article 404 can include one or more features 408 that engage with component 450 so as to maintain article 404 in position. As shown, feature 408 can be a ride or other projection, but can also be a groove, hole, or other depression. Likewise, component 450 can include one or more features 406 that engage with a feature of article 404 or with article 404 more generally. Such features can be, e.g., ridges, grooves, projections, holes, depressions, and the like. Component 450 can include a stop feature (e.g., a wall or peg) that is configured to prevent article 404 from being inserted too deeply into space 402. Article 404 can be held in place via friction or interference fit; it can also be held in place by way of a bayonet-type or other rotatable coupling.

It should be understood that the disclosed components can also include one or more heating bodies 407, which can comprises a material that is susceptible to induction heating. A heating body can in turn be inductively heated by coil 402, and the heating body can then in turn heat at least a portion of article 404.

Additionally, although coil 402 is shown in a helical configuration, coil 402 can also be in a planar coil configuration, e.g., to a coiled rope on a floor. Likewise, heating body 407 can be of virtually any shape, e.g., a panel or a bar.

A component can include one, two, or more coils. A coil can be of virtually any design, e.g., a helical coil, a single-turn coil, a multi-position helical coil (e.g., a coil that comprises two helices), a channel coil, a curved channel coil, a pancake coil, a split helical coil, an internal coil (e.g., in which the coil is disposed within the induction-susceptible material), a concentrator plate coil (e.g., where a concentrator plate is used to focus the coil current to produce a defined heating effect), or a hair-pin coil. In some embodiments, one coil can also act as an induction-susceptible for another second coil and thereby induced to heat.

Article 404 can be removeable, e.g., a removeable consumable cartridge or ampule. Article 404 can comprise one or more materials that is susceptible to inductive heating, e.g., a metal or mixture of metals.

As one example, article 404 can comprise a package of smokeable material (e.g., a material that comprises tobacco, nicotine, or both) that includes metal flakes therein. When coil 402 is operated, the operation of coil 402 gives rise to heating of the metal flakes within article 404, which in turn heats and vaporizes the vaporizable material within article 404. As another example, article 404 can include one or more wires or metallic traces therein, which wires or metallic traces are susceptible to inductive heating. Article 404 can have a uniform distribution of induction-susceptible material therein, but this is not a requirement. For example, article 404 can include a region of relatively higher susceptibility to inductive heating and a region of relatively lower susceptibility to inductive heating.

Article 404 can be cylindrical, but can also be cuboid in configuration. Article 404 can be elongate along a major axis having a length L, and can have a width W (which can be measured in a direction that is perpendicular to the major axis) that is less than length L.

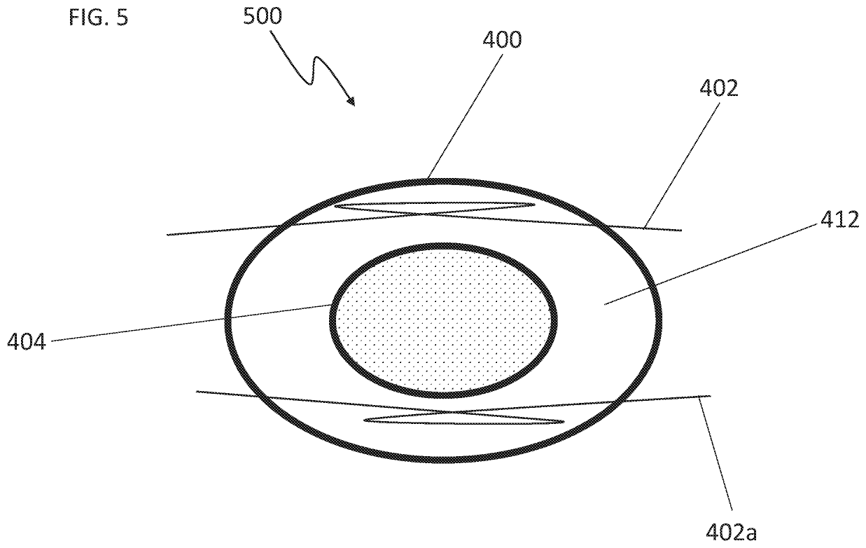

FIG. 5 provides a further embodiment of a component 500 according to the present disclosure. As shown, component 500 includes a boundary 400, with article 404 disposed within the boundary 400. (Suitable boundaries and articles are described elsewhere herein.) Component 500 can include (not shown) a material disposed along the inner surface of boundary 404, e.g., a ceramic. Component 500 can include first coil 402 and second coil 402a, which coils can be operated to effect inductive heating of susceptible material disposed between the coils, e.g., susceptible material disposed within or on article 404. The coils can also be operated to effect inductive heating of susceptible material (not shown) located between a coil and article 404.

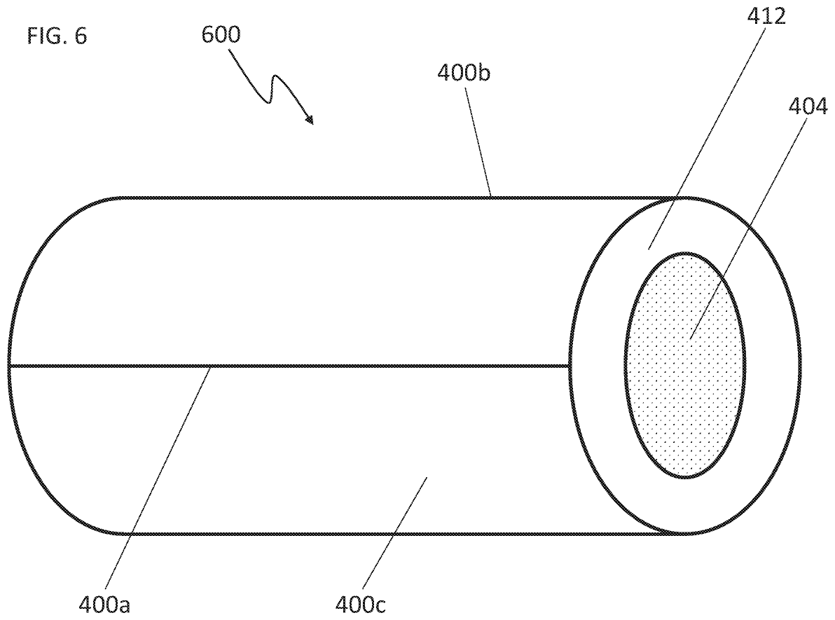

FIG. 6 provides another embodiment of the disclosed components. As shown, article 404 is disposed within space 412. Space 412 is in turn defined within boundary segment 400b and boundary segment s400c, which boundaries are joined at seam 400a. Thus, an article can be enclosed within one, two, or more boundaries. As shown in FIG. 6, a component can comprise a boundary that is “split” longitudinally, as shown by seam 400a.

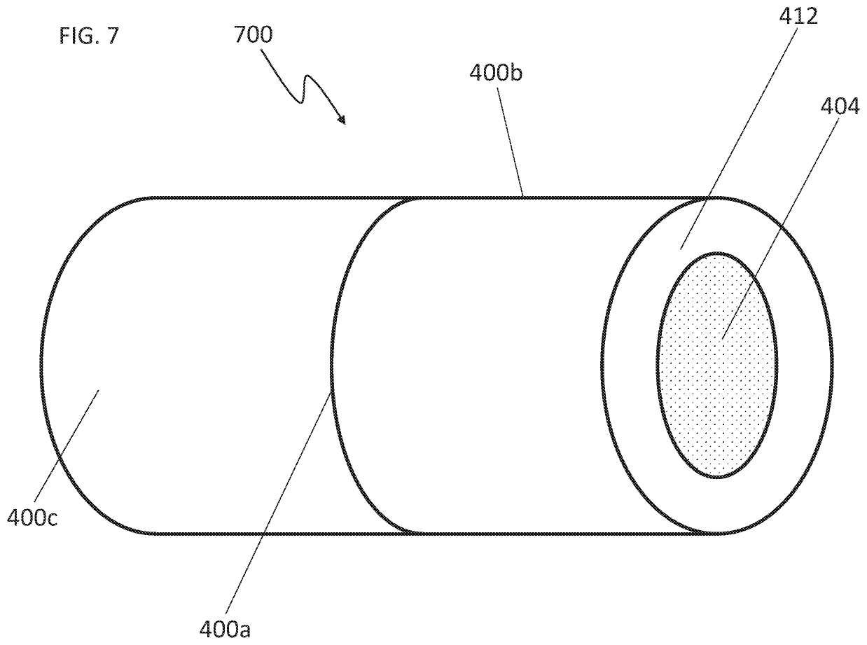

FIG. 7 provides another embodiment of the disclosed components. As shown, article 404 is disposed within space 412. Space 412 is in turn defined within boundary segment 400b and boundary 400c, which boundaries are joined at seam 400a. Thus, an article can be enclosed within one, two, or more boundaries. As shown in FIG. 6, a component can comprise a boundary that is “split” horizontally (as opposed to longitudinally), as shown by seam 400a. It should be understood, however, that a boundary can be split in manners other than those shown in illustrative FIG. 6 and illustrative FIG. 7. Further, a boundary need not be formed from segments that form a continuous shape, such as the cylinder shown in FIG. 6. A boundary can be formed from, e.g., boundary segment panels that are opposed to one another, similar to the covers of a book enclosing the pages therebetween.

### Exemplary Embodiments

The following embodiments are illustrative only and do not necessarily limit the scope of the present disclosure or the appended claims.

Embodiment 1. An insulating module, comprising: a nonconducting first shell; a conducting first component, the first shell being disposed about the first component, (a) the first shell comprising a sealed evacuated insulating space, (b) the first shell and first component having a first sealed evacuated insulating space therebetween, the first component comprising a sealed evacuated insulating space, or any one or more of (a), (b), and (c); and a current carrier configured to give rise to inductive heating.

The first shell can be formed of a dielectric material, e.g., a ceramic. Crystalline and non-crystalline ceramics are considered suitable. The first shell and first component can be brazed together; suitable brazing techniques are known to those in the art and some exemplary techniques are presented in the documents cited elsewhere herein.

The first component can be, e.g., a tube, in some embodiments. The first component can also be solid, e.g., a cylinder. In some embodiments, the first shell and the first component are arranged coaxially, e.g., as concentric tubes. The first shell and the first component can have the same cross-sectional shape (e.g., circular, oblong, polygonal), but this is not a requirement. As one example, the first shell can be hexagonal in cross-section, and the first component can be circular in cross-section. It should also be understood that the first shell and the first component need not be arranged coaxially with one another.

The first component can comprise a dielectric material, e.g., a ceramic. This is not a requirement, however, as the first component can comprise a metal or other material that can be inductively heated. The first component can comprise a cermet material.

Embodiment 2. An insulating module, comprising: a conducting first shell; a non-conducting first component, the first shell being disposed about the first component, (a) the first shell comprising a sealed evacuated insulating space, (b) the first shell and first component having a first sealed evacuated insulating space therebetween, the first component comprising a sealed evacuated insulating space, or any one or more of (a), (b), and (c); and a current carrier configured to give rise to inductive heating.

The first shell can comprise a metal, e.g., stainless steel, an alloy, and the like. The first shell need not be completely metallic, however, and can comprise a cermet material in some embodiments.

The non-conducting first component can comprise a dielectric, e.g., a ceramic. Crystalline and non-crystalline ceramic materials can be used.

Embodiment 3. An insulating module, comprising: a non-conducting first shell; a non-conducting first component, the first shell being disposed about the first component, (a) the first shell comprising a sealed evacuated insulating space, (b) the first shell and first component having a first sealed evacuated insulating space therebetween, the first component comprising a sealed evacuated insulating space, or any one or more of (a), (b), and (c); and a current carrier configured to give rise to inductive heating. Without being bound to any particular theory, the current carrier can give rise to inductive heating of an additional component of the module, to inductive heating of a consumable engaged with the module, or any combination thereof.

Embodiment 4. The insulating module according to any one of Embodiments 1-3, further comprising a second sealed evacuated space disposed about the first shell, the second sealed evacuated space optionally being configured to contain heat evolved by the current carrier. As but one example, this can take the form of three concentric (inner, middle, and outer) tubes wherein there is a first sealed evacuated space between the inner and middle tubes and a second sealed evacuated space between the middle and outer tubes.

Embodiment 5. The insulating module according to any one of Embodiments 1-4, wherein the insulating module is configured to communicate a fluid within the first sealed evacuated insulating space. There can be one or more ports formed in the module so as to communicate the fluid into or out of the insulating space.

Embodiment 6. The insulating module according to any one of Embodiments 1-5, wherein the current carrier is disposed about the first shell, the current collector optionally contacting the first shell or optionally being integrated into the first shell. A barrier layer or coating can be used to prevent contact between the current collector and the first shell. The current collector can contact or even be integrated into the first shell, in some embodiments.

Embodiment 7. The insulating module according to any one of Embodiments 1-5, wherein the current carrier is disposed within the first sealed evacuated insulating space, the current collector optionally contacting one or both of the first shell and the first component or optionally being integrated into one or both of the first shell and the first component.

As one example, the current collector can be formed into the material of the first shell and/or first component. This can be accomplished by, e.g., molding the material of the first shell (e.g., a ceramic) around the material of the current collector. The current collector can be bonded to the first shell (and/or to the first component), but this is not a requirement.

In some embodiments, the current collector extends at least partially into or through the first shell and/or the first component in one or more locations. As an example, the first shell can include one or more apertures through which the current collector extends. It is not a requirement that the current collector pass through the first shell. As one example, the current collector can be wrapped around the first shell without extending through the material of the first shell.

Embodiment 8. The insulating module according to any one of Embodiments 1-5, wherein the current carrier is disposed within the first component, the current collector optionally contacting the first component or optionally being integrated into the first component. The current collector can be bonded to the first component. In some embodiments, the current collector extends at least partially into or through the first component at one or more locations.

As an example, the current collector can be wound as a coil within the lumen of the first component, as shown in exemplary FIG. 1C. It should be understood that the current collector need not extend through the material of the first component or the first shell, as the current collector could extend into the lumen of the first component without also extending through the material of the first component or of the first shell.

Embodiment 9. The insulating module according to any one of Embodiments 1-5, wherein the current carrier is configured to effect inductive heating of a working material disposed within the first component. As one such example, a working material can be disposed within the lumen of the first component.

The heating can be effected by giving rise to inductive heating directly within the working material itself. This can be applied in embodiments where the working material includes a component (e.g., a metal) that supports being inductively heated. This can also be effected where the current collector gives rise to heating of an element (e.g., element 114 in FIG. 1C) that in turn heats the working material. This can further be effected by inductive heating of at least a portion of the first shell and/or the first component.

Some suitable working materials (or consumables) useful in the disclosed modules include, e.g., metals, polymers, and the like. Plant-based materials (e.g., tobacco, herbal materials) are suitable working materials. Working materials that are flowable under heating and then resolidify under cooling are especially suitable, as such working materials are suited for additive manufacturing applications. A working material that is smokeable and/or partially vaporizes with heating is also suitable. A working material (consumable) can include a material that is sensitive to inductive heating, e.g., a metallic material. A device (and/or method) according to the present disclosure can maintain or change the temperature of a working material that is being processed, e.g., in a mass spectrometer or cooking oil filtration application. A device can include a temperature controller train, which train can be configured to maintain (or adjust) a temperature of a working material, a temperature of an element of the device, or a temperature at a location within the device. One or more temperature sensors (e.g., a thermocouple) can be disposed within a device according to the present disclosure. It should be understood that a device according to the present disclosure can include, e.g., a heat source (e.g., a heating element). A device can include a power source, which power source can be configured to effect operation of the heat source. A device can include one or more indicators (e.g., an LED) configured to advise regarding a status (e.g., a temperature, an operating time, and the like) of the device. Devices according to the present disclosure can be constructed in a modular fashion, e.g., such that the coil can be removed and replaced, although this is not a requirement.

A working material can also be a liquid, semi-solid, or other non-solid form. In such embodiments, the working material can be comprised within a container, e.g., a capsule, cartridge, or other vessel. Such a vessel can include one or more pores, apertures, or passages configured to allow passage of smoke and/or vapor evolved from heating the working material. In some embodiments, the module can be configured to pierce a container (e.g., a capsule) so as to heat a material (e.g., a liquid) disposed therein. (The working material can, alternatively, be a consumable.) Working material can be shaped into a desired form, e.g., a cylinder, disc, plug, and the like. A working material can be shaped so as to engage with a locating feature (e.g., a ridge) that is configured to maintain the working material in location. It should be understood that modules according to the present disclosure can include one or more passages or spaces that allow a user to inhale one or more products evolved by heating a working material or consumable.

Embodiment 10. The insulating module according to any one of Embodiments 1-5, wherein the current carrier is configured to effect inductive heating of a working material disposed exterior to the first shell. The working material can be present as, e.g., a ring or coil disposed exterior to the first shell. There can be a further (e.g., second) shell disposed about such working material, and the further shell can define a further sealed, evacuated insulating space about the working material exterior to the first shell.

Embodiment 11. The insulating module of Embodiment 1, wherein the first shell comprises a ceramic.

Embodiment 12. The insulating module of Embodiment 2 or Embodiment 3, wherein the first component comprises a ceramic.

Embodiment 13. The insulating module according to any one of Embodiments 1-12, wherein one or both of the first shell and the first component comprises a shield that is at least partially opaque to a magnetic field. Such a shield can be, e.g., a magnetically-opaque material or even a Faraday cage. The shield can be passive or active; as examples, a solenoid or Helmholtz coil can be used.

Embodiment 14. The insulating module according to any one of Embodiments 1-13, wherein the first component defines a lumen therein. This can be, e.g., in an embodiment where the first component is tubular.

Embodiment 15The insulating module of Embodiment 14, wherein the lumen of the inner shell defines a proximal end and a distal end. The lumen can have a constant cross-section along the length of the lumen, but can also have a variable cross-section.

Embodiment 16. The insulating module of Embodiment 15, wherein (a) the proximal end defines a cross-section, (b) the distal end defines a cross-section, and (c) the cross-section of the proximal end differs from the cross-section of the distal end.

The module can include a nozzle at one or both ends. Such a nozzle can be configured to dispense working material that has been heated and/or communicated through the module. The lumen can narrow (or flare) from one end to the other.

Embodiment 17. The insulating module according to any one of Embodiments 14-16, wherein the lumen of the first component is in fluid communication with a source of fluid. Such a fluid can be, e.g., a cleaning fluid, a flux, a cooling fluid, and the like.

Embodiment 18. The insulating module according to any one of Embodiments 1-17, wherein at least one of the first shell and the first component is essentially resistant to evolving inductive heat.

Embodiment 19. The insulating module according to any one of Embodiments 1-18, wherein the current carrier is characterized as helical. A current carrier can include, e.g., 1, 2, 3, 4, 5, 6, 7, 8, 9, 10, or more loops.

Embodiment 20. The insulating module according to any one of Embodiments 1-19, wherein the current carrier is in communication with a device configured to modulate a current communicated through the current carrier.

Such a device can include, e.g., a controllable current source configured to modulate the passage of current through the current carrier. Control of the current source can be manual, but it can also be automated. As one example, a module can be configured to heat working material to within a certain range of temperatures.

Embodiment 21. The insulating module according to any one of Embodiments 1-20, further comprising an amount of heat-sensitive working material disposed within the first component. Such a material can include, e.g., a metal, a polymer, and the like.

Embodiment 22. The insulating module according to any one of Embodiments 1-21, further comprising an amount of heat-sensitive working material disposed exterior to the first shell.

Embodiment 23. The insulating module according to any one of Embodiments 21-22, wherein the heat sensitive working material comprises a metal.

Embodiment 24. The insulating module of Embodiment 23, wherein the heat-sensitive working material is characterized as a wire.

Embodiment 25. The insulating module according to any one of Embodiments 21-24, wherein the heat-sensitive working material comprises a polymeric material.

Embodiment 26. The insulating module according to any one of Embodiments 22-25, wherein the heat-sensitive working material comprises a flux material.

Embodiment 27. The insulating module according to any one of Embodiments 1-26, further comprising an element configured to be inductively heated by the current carrier. Such an element can be, e.g., a wire, a ribbon, and the like. The element can comprise a metal, e.g., iron, nickel, cobalt, gadolinium, dysprosium, steel, and the like.

The element can be straight or linear, but can also be curved, bent, or otherwise nonlinear. In some embodiments, the element is inductively heated by the current carrier, with the heating of the element in turn heating a working material disposed within the insulating module. As one example, the element can be heated via induction heating, and the heated element can in turn heat the working working material.

Modules according to the present disclosure can include one, two, three, or more elements. Similarly, a module according to the present disclosure can include one, two, or more current collectors. In this way, a module can be configured to effect inductive heating at different elements within the module. This in turn allows one to effect a heating profile within the module that varies with location and/or varies with time.

Embodiment 28. The insulating module of Embodiment 27, wherein the element is disposed within the first component.

Embodiment 29. The insulating module of Embodiment 27, wherein the element is disposed within the first sealed evacuated insulating space.

Embodiment 30. The insulating module of Embodiment 27, wherein the element is disposed exterior to the first shell.

Embodiment 31. The insulating module of claim 1, wherein the first component is characterized as a can or a tube in configuration, the first component having an interior surface that defines an interior volume of the first component. (FIG. 2A provides a non-limiting example of such an embodiment.)

Embodiment 32. The insulating module of claim 31, wherein the first shell is characterized as being tubular or a can in configuration.

Embodiment 33. The insulating module of claim 32, wherein the first component and the first shell are arranged coaxially with one another, about a first axis.

Embodiment 34. The insulating module of any one of claims 32-33, wherein the first component comprises a depression formed therein, the depression extending into the interior volume of the first component

Embodiment 35. The insulating module of claim 34, further comprising a coil container disposed about the current carrier, the coil container being disposed within the depression, and the current carrier being at least partially disposed within the coil container.

Embodiment 36. The insulating module of claim 35, wherein the coil container comprises an inner wall, an outer wall, and a sealed evacuated space formed therebetween.

Embodiment 37. The insulating module of claim 36, wherein a line extending radially outwardly and orthogonally from the first axis of the insulating module extends through the coil container, the depression, the first component, and the first shell.

An illustration of this can be found in FIG. 2C, which shows first axis 1250 and line 1252 extending radially outwardly and orthogonally from first axis 1250. As shown, line 1252 extends through coil container 1208, depression (cup 1205), first component 1203, and first shell 1219. In this way, the amount of induction is reduced as one moves outward along line 1252.

Embodiment 38. A method, comprising: operating the current carrier of an insulating module according to any one of Embodiments 1-37 so as to increase, by inductive heating, the temperature of a working material disposed within the inner shell of the insulating module.

Embodiment 39. The method of Embodiment 38, further comprising heating the working material so as to render the working material flowable.

Embodiment 40. The method according to any one of Embodiments 38-39, wherein the working material is a polymeric material, a metallic material, or any combination thereof. In some embodiments, the material can comprise a polymer having metallic portions disposed therein. Such a working material can then be inductively heated, as the metallic portions of the material will be sensitive to inductive heating and will in turn heat the material at large.

Embodiment 41. The method according to any one of Embodiments 38-40, wherein the working material is inductively heated by the current carrier.

Embodiment 42. The method according to any one of Embodiments 38-41, wherein the working material is heated so as to achieve a phase change of the material. Such a phase change can be from solid to liquid, but can also be from solid to gas/vapor, e.g., a volatilization.

Embodiment 43. The method according to any one of Embodiments 38-42, further comprising communicating the working material within the module so as to effect additive manufacture of a workpiece. Exemplary workpieces include, e.g., gears, housings, shells, tubes, wedges, lenses, straps, tabs, handles, and the like. A component according to the present disclosure can be in communication with a working material (e.g., a polymer filament, a polymeric powder) and be operated so as to effect additive manufacturing using the working material. As described elsewhere herein, the working material can itself include a material that is sensitive to inductive heating.

The communication of the can be effected mechanically, e.g., via a plunger or other mechanical element. The communication can also be effected by gravity or even by an applied pressure.

Embodiment 44. The method according to any one of Embodiments 38-43, further comprising communicating a cover fluid within the first sealed evacuated insulating space. Such a cover fluid can be a liquid or gas, and can be used to absorb heat present in the evacuated insulating space.

Embodiment 45. The method of Embodiment 44, wherein the fluid is introduced as a liquid and evaporated to gas form. In such an approach, the fluid is vaporized, thereby absorbing heat present in the evacuated insulating space.

Embodiment 46. An insulating module, comprising: a first shell that comprises a material sensitive to inductive heating, the first shell having a first sealed evacuated insulating space therein; and a current carrier configured to give rise to inductive heating of the material sensitive to inductive heating.

Such modules can include, e.g., a jig, collar, or other module configured to maintain in position a consumable that is inserted into the module. The module can be (e.g., via operation of the current carrier) operated to heat the consumable. Other features that can be present in the modules are provided in the other foregoing Embodiments.

Embodiment 47. An insulating module, comprising: a first shell, the first shell comprising a sealed evacuated insulating space; a first component, the first component being disposed within the first shell and the first component comprising a material that is sensitive to inductive heating, the first component being disposed within the first shell, the first component being configured to receive a consumable; an induction heating coil, the induction heating coil being configured to give rise to inductive heating of the first component.

Embodiment 48. The insulating module of Embodiment 47, wherein the first shell and the first component are cylindrical in configuration and are arranged coaxially with one another.

Embodiment 49. The insulating module of Embodiment 48, wherein the first component comprises a flat bottom portion, and wherein the induction heating coil is disposed on the flat bottom portion.

The disclosed modules are not limited in size, and can in fact be of any size that accords with the user's needs. As one example, a module according to the present disclosure can define a diameter of, e.g., from about 10 mm to about 20 mm, in some embodiments. An insulating module according to the present disclosure can be of virtually any length. As one example, an insulating module according to the present disclosure can have a length of from, e.g., about 20 mm to about 200 mm.

A module can also comprise a power source that is in electrical communication with the current collector. Such a source can be, e.g., a battery or other capacitor. Power sources can be rechargeable or disposable. A module can be portable or be stationary or be “plug-in” in configuration.

It should also be understood that modules according to the present disclosure can be useful in a broad range of applications. A non-limiting list of such applications includes, e.g., additive manufacturing, materials processing (e.g., phase change of materials, heat-based separation of one or more materials from a “base” material, and the like). A module according to the present disclosure can, in turn, be incorporated into a variety of systems.

Embodiment 50. A component, comprising: a first wall; a second wall, the second wall arranged at a distance from the first wall; a support material disposed between the first wall and second wall so as to maintain a spacing between the first wall and the second wall, the support material optionally being thermally degradable.

Suitable wall materials include, e.g., stainless steel and ceramics. Support materials can be metallic, e.g., a metallic foam or metallic fibers. A support material can also be ceramic in nature.

Embodiment 51. The component of Embodiment 50, wherein (a) the first wall defines a portion that converges toward the second wall, (b) the second wall defines a portion that converges toward the first wall, or both (a) and (b).

Embodiment 52. The component of any one of Embodiments 50-51, wherein (a) the first wall defines a groove that is concave away from the second wall, (b) the second wall defines a groove that is concave away from the first wall, or both (a) and (b).

Embodiment 53. The component of any one of Embodiments 50-52, wherein at least one of the first wall and the second wall comprises a ceramic material.

Embodiment 54. The component of Embodiment 53, wherein at least one of the first wall and the second wall is a green ceramic material that cures at a curing temperature.

Embodiment 55. The component of Embodiment 54, wherein the support material degrades at a temperature higher than the curing temperature.

Embodiment 56. The component of any one of Embodiments 50-55, wherein the thermally degradable support material is configured to occupy, upon degradation, at least a portion of an opening between the first wall and the second wall. This can be accomplished, e.g., by the support material attaining a fluid form and then being transported into the opening. Support material can then in turn act to seal the opening.

Embodiment 57. The component of any one of Embodiments 50-56, wherein at least one of the first wall and the second wall comprises therein a material susceptible to inductive heating. As described elsewhere herein, the susceptible material can be mixed into or even doped into the wall material.

Embodiment 58. A method, comprising: with a workpiece comprising a first wall and a second wall, the second wall arranged at a distance from the first wall, the workpiece further comprising a support material disposed between the first wall and second wall so as to maintain a spacing between the first wall and the second wall, the support material optionally being thermally degradable; effecting by application of thermal energy a seal between the first wall and the second wall so as to define a sealed evacuated space between the first wall and the second wall.

Embodiment 59. The method of Embodiment 58, wherein the first wall comprises a green ceramic or green glass-ceramic material and the method further comprising curing the first wall.

Embodiment 60. The method of any one of Embodiments 58-59, further comprising effecting thermal degradation of the support material.

Embodiment 61. The method of Embodiment 60, further comprising effecting movement of degraded support material into an opening between the first wall and the second wall.

Embodiment 62. A component, comprising: at least one boundary segment defining a receiving zone configured to receive an article, the at least one boundary segment comprising a ceramic material or comprising a ceramic material disposed thereon; and (a) at least one heating coil configured to effect inductive heating of the article, (b) a heating body and at least one heating coil configured to effect inductive heating of the heating body so as to heat the article, or (c) both (a) and (b).

Embodiment 63. The component of Embodiment 62, further comprising a feature configured to engage with the article so as to maintain the article in position relative to the at least one boundary segment. Suitable features are described elsewhere herein and include, e.g., ridges, grooves, bumps, depressions, and the like.

Embodiment 64. The component of any one of Embodiments 62-63, further comprising a power source operatively connected to the heating coil. A component can also include a controller configured to modulate a current applied through the heating coil.

Embodiment 65. The component of any one of Embodiments 62-64, wherein the boundary segment is characterized as being cylindrical in configuration.

Embodiment 66. The component of any one of Embodiments 62-65, wherein the boundary segment comprises a first wall and a second wall, the first wall and the second wall defining a sealed insulating space therebetween.

Embodiment 67. The component of Embodiment 66, wherein the heating coil is at least partially disposed within the sealed insulating space.

Embodiment 68. The component of any one of Embodiments 62-66, wherein the heating coil is at least partially disposed within the receiving zone.

Embodiment 69. The component of any one of Embodiments 62-68, wherein the component comprises a plurality of boundary segments, the plurality of boundary segments being configured to be attachably assembled about the article. As an example, two hemi-cylindrical boundary segments can be assembled so as to enclose the article.

Embodiment 70. The component of any one of Embodiments 62-69, wherein the heating coil is configured to at least partially encircle the article when the article is disposed within the receiving zone.

Embodiment 71. The component of any one of Embodiments 62-70, further comprising a heating body disposed so as to be inductively heated by the heating coil. A heating body can be a road, panel, platelet, or other-shaped body. The heating body can be disposed so as to contact the article, but can also be disposed so as to be spaced at a distance from the article.

Embodiment 72. The component of any one of Embodiments 62-71, wherein the heating coil is configured to operate as a resistive heating coil. In some embodiments, a component can include two or more heating coils. In some embodiments, one coil can be configured to operate as an inductive heating coil and another coil can be configured to operate as a resistive heating coil. In this manner, a component can be operated to heat an article (e.g., a mass of smokeable material) by application of both inductive heating and resistive heating.

Embodiment 73. The component of any one of Embodiments 62-72, wherein the component comprises at least two boundary segments, the at least two boundary segments comprising one or more ceramic materials.

Embodiment 74. The component of any one of Embodiments 62-73, wherein the at least one heating coil is at least partially in register with the receiving zone.

1. An insulating module, comprising:
(i) a nonconducting first shell;
a conducting first component,
the first shell being disposed about the first component,
(a) the first shell comprising a sealed evacuated insulating space, (b) the first shell and first component having a first sealed evacuated insulating space therebetween, (c) the first component comprising a sealed evacuated insulating space, or any one or more of (a), (b), and (c); and
a current carrier configured to give rise to inductive heating; or,—
(ii) a conducting first shell;
a non-conducting first component,
the first shell being disposed about the first component,
(a) the first shell comprising a sealed evacuated insulating space, (b) the first shell and first component having a first sealed evacuated insulating space therebetween, (c) the first component comprising a sealed evacuated insulating space, or any one or more of (a), (b), and (c); and
a current carrier configured to give rise to inductive heating, or
(iii) a non-conducting first shell;
a non-conducting first component,
the first shell being disposed about the first component,
(a) the first shell comprising a sealed evacuated insulating space, (b) the first shell and first component having a first sealed evacuated insulating space therebetween, (c) the first component comprising a sealed evacuated insulating space, or any one or more of (a), (b), and (c); and
a current carrier configured to give rise to inductive heating.

2. (canceled)

3. (canceled)

4. The insulating module of claim 1, further comprising a second sealed evacuated space disposed about the first shell, the second sealed evacuated space optionally being configured to contain heat evolved by the current carrier.

5. The insulating module of claim 1, wherein the insulating module is configured to communicate a fluid within the first sealed evacuated insulating space.

6. The insulating module of claim 1, wherein the current carrier is disposed about the first shell, the current collector optionally contacting the first shell or optionally being integrated into the first shell.

7. The insulating module of claim 1, wherein the current carrier is disposed within the first sealed evacuated insulating space, the current collector optionally contacting one or both of the first shell and the first component or optionally being integrated into one or both of the first shell and the first component.

8. The insulating module within of claim 1, wherein the current carrier is disposed within the first component, the current collector optionally contacting the first component or optionally being integrated into the first component.

9. The insulating module of claim 1, wherein the current carrier is configured to effect inductive heating of a working material disposed within the first component.

10. (canceled)

11. The insulating module of claim 1, wherein the first shell comprises a ceramic.

12. (canceled)

13. The insulating module of claim 1, wherein one or both of the first shell and the first component comprises a shield that is at least partially opaque to a magnetic field.

14. (canceled)

15. (canceled)

16. (canceled)

17. (canceled)

18. The insulating module of claim 1, wherein at least one of the first shell and the first component is essentially resistant to evolving inductive heat.

19. The insulating module of claim 1, wherein the current carrier is characterized as helical.

20. (canceled)

21. The insulating module of claim 1, further comprising an amount of heat-sensitive working material disposed within the first component.

22. (canceled)

23. (canceled)

24. (canceled)

25. (canceled)

26. (canceled)

27. The insulating module of claim 1, further comprising an element configured to be inductively heated by the current carrier.

28. The insulating module of claim 27, wherein the element is disposed within the first component.

29. (canceled)

30. (canceled)

31. The insulating module of claim 1, wherein the first component is characterized as a can or a tube in configuration, the first component having an interior surface that defines an interior volume of the first component.

32. (canceled)

33. The insulating module of claim 1, wherein the first component and the first shell are arranged coaxially with one another, about a first axis.

34. (canceled)

35. (canceled)

36. (canceled)

37. (canceled)

38. A method, comprising: operating the current carrier of an insulating module according to claim 1 so as to increase, by inductive heating, the temperature of a working material disposed within the inner shell of the insulating module.

39. (canceled)

40. (canceled)

41. (canceled)

42. (canceled)

43. (canceled)

44. (canceled)

45. (canceled)

46. (canceled)

47. An insulating module, comprising: a first shell, the first shell comprising a sealed evacuated insulating space; the insulating module being configured to receive a consumable; an induction heating coil being disposed within the first shell, the induction heating coil being configured to give rise to inductive heating of the consumable.

48. The insulating module of claim 47, wherein the first shell and the first component are cylindrical in configuration and are arranged coaxially with one another.

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. A component, comprising:
at least one boundary segment defining a receiving zone configured to receive an article,
the at least one boundary segment comprising a ceramic material or comprising a ceramic material disposed thereon; and
(a) at least one heating coil configured to effect inductive heating of the article,
(b) a heating body and at least one heating coil configured to effect inductive heating of the heating body so as to heat the article, or
(c) both (a) and (b).

63. The component of claim 62, further comprising a feature configured to engage with the article so as to maintain the article in position relative to the at least one boundary segment.

64. (canceled)

65. The component of claim 62, wherein the boundary segment is characterized as being cylindrical in configuration.

66. (canceled)

67. (canceled)

68. (canceled)

69. (canceled)

70. The component of claim 47, wherein the induction heating coil is configured to at least partially encircle the consumable when the consumable is disposed within the first shell.

71. The component of claim 47, further comprising a heating body within the first shell and disposed so as to be inductively heated by the induction heating coil.

72. (canceled)

73. (canceled)

74. (canceled)

75. (canceled)

76. (canceled)

77. (canceled)

78. (canceled)

79. (canceled)

80. The insulating module of claim 1, wherein the conducting first shell and the nonconducting first component define a sealed evacuated insulating space therebetween,
wherein the insulating module is configured to receive a consumable, and
wherein the current carrier is disposed within the nonconducting first component so as to be disposed about the consumable received by the insulating module.

81. The insulating module of claim 80, further comprising a heating body susceptible to induction heating and configured to be heated inductively by the current carrier so as to heat the consumable.

82. The insulating module of claim 81, wherein the heating body is configured for insertion into the consumable.

83. The insulating module of claim 80, wherein the consumable comprises a material susceptible to inductive heating by the current carrier.

84. (canceled)

85. The insulating module of claim 1, wherein the nonconducting first shell and the nonconducting first component define a sealed evacuated insulating space therebetween,
wherein the insulating module is configured to receive a consumable, and
wherein the current carrier is disposed within the conducting first component so as to be disposed about the consumable received by the insulating module.

86. The insulating module of claim 85, further comprising a heating body susceptible to induction heating and configured to be heated inductively by the current carrier so as to heat the consumable.

87. The insulating module of claim 86, wherein the heating body is configured for insertion into the consumable.

88. The insulating module of claim 85, wherein the consumable comprises a material susceptible to inductive heating by the current carrier.

89. (canceled)
